(19) United States
(12) Patent Application Publication
(10) Pub. No.: US 2021/0036816 A1
(43) Pub. Date: Feb. 4, 2021

(54) METHODS AND APPARATUSES FOR NON-ORTHOGONAL MULTIPLE ACCESS RESOURCE UTILIZATION SCALABILITY

(71) Applicant: Nokia Technologies Oy, Espoo (FI)

(72) Inventors: Chunhai Yao, Beijing (CN); Yuantao Zhang, Beijing (CN)

(21) Appl. No.: 17/045,574

(22) PCT Filed: Apr. 6, 2018
(86) PCT No.: PCT/CN2018/082097

§ 371 Date: Oct. 6, 2020

(51) Int. Cl. H04L 5/00

(52) U.S. Cl. CPC H04L 5/0016; H04L 5/0094; H04L 5/0044

(57) ABSTRACT

Systems, methods, apparatuses, and computer program products for non-orthogonal multiple access (NOMA) resource utilization scalability are provided. One method may include configuring the number of physical resource blocks (PRBs) allocated for NOMA usage in a cell-specific manner. At least a parameter may be configured and used in determining the number of PRBs allocated for the NOMA. The parameter may refer to at least one of a spreading factor for a spreading based NOMA scheme, or to a repetition number for an interleaver/scrambling based NOMA scheme. The method may also include defining at least one mapping pattern to indicate a mapping of user data to the physical resource blocks.

### FIELD

Some example embodiments may generally relate to mobile or wireless telecommunication systems, such as Long Term Evolution (LTE) or fifth generation (5G) radio access technology or new radio (NR) access technology. Certain embodiments may relate to non-orthogonal multiple access (NOMA) is such communication systems.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-A Pro, and/or fifth generation (5G) radio access technology or new radio (NR) access technology. Fifth generation (5G) or new radio (NR) wireless systems refer to the next generation (NG) of radio systems and network architecture. It is estimated that NR will provide bitrates on the order of 10-20 Gbit/s or higher, and will support at least enhanced mobile broadband (eMBB) and ultra-reliable low-latency-communication (URLLC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G or NR, the nodes that can provide radio access functionality to a user equipment (i.e., similar to Node B in E-UTRAN or eNB in LTE) may be referred to as a next generation or 5G Node B (gNB).

### SUMMARY

One embodiment is directed to a method that may include configuring a number of physical resource blocks (PRBs) allocated for non-orthogonal multiple access (NOMA) usage in a cell-specific manner. At least a parameter may be configured and used in determining the number of PRBs allocated for the NOMA. The parameter may refer to at least one of a spreading factor for a spreading based NOMA scheme, or to a repetition number for an interleaver/scrambling based NOMA scheme. The method may also include defining at least one mapping pattern to indicate a mapping of user data to the PRBs.

Another example embodiment is directed to an apparatus, which may include at least one processor and at least one memory comprising computer program code. The at least one memory and computer program code configured, with the at least one processor, to cause the apparatus at least to configure a number of PRBs allocated for NOMA usage in a cell-specific manner, where at least a parameter may be configured and used in determining the number of PRBs allocated for the NOMA. The parameter may refer to at least one of a spreading factor for a spreading based NOMA scheme, or to a repetition number for an interleaver/scrambling based NOMA scheme. The at least one memory and computer program code may be further configured, with the at least one processor, to cause the apparatus at least to define at least one mapping pattern to indicate a mapping of user data to the physical resource blocks.

Another embodiment is directed to an apparatus that may include configuring means for configuring a number of PRBs allocated for NOMA usage in a cell-specific manner, where at least a parameter may be configured and used in determining the number of PRBs allocated for the NOMA. The parameter may refer to at least one of a spreading factor for a spreading based NOMA scheme, or to a repetition number for an interleaver/scrambling based NOMA scheme. and the apparatus may further include defining means for defining at least one mapping pattern to indicate a mapping of user data to the physical resource blocks.

Another embodiment is directed to a non-transitory computer readable medium comprising program instructions stored thereon for performing at least the following: configuring a number of PRBs allocated for NOMA usage in a cell-specific manner, where at least a parameter may be configured and used in determining the number of PRBs allocated for the NOMA and the parameter may refer to at least one of a spreading factor for a spreading based NOMA scheme or to a repetition number for an interleaver/scrambling based NOMA scheme, and defining at least one mapping pattern to indicate a mapping of user data to the PRBs.

Another embodiment is directed to method that may include receiving or selecting, by a user equipment, at least one mapping pattern to use for mapping of user data to allocated PRBs for NOMA, and mapping the user data to the PRBs allocated for the NOMA according to the at least one mapping pattern.

Another example embodiment is directed to an apparatus, which may include at least one processor and at least one memory comprising computer program code. The at least one memory and computer program code configured, with the at least one processor, to cause the apparatus at least to receive or select at least one mapping pattern to use for mapping of user data to allocated PRBs for NOMA, and to map the user data to the PRBs allocated for the NOMA according to the at least one mapping pattern.

Another embodiment is directed to an apparatus that may include means for receiving or selecting at least one mapping pattern to use for mapping of user data to allocated PRBs for NOMA, and means for mapping the user data to the PRBs allocated for the NOMA according to the at least one mapping pattern.

Another embodiment is directed to a non-transitory computer readable medium comprising program instructions stored thereon for performing at least the following: receiving or selecting at least one mapping pattern to use for mapping of user data to allocated PRBs for NOMA, and mapping the user data to the PRBs allocated for the NOMA according to the at least one mapping pattern.

### BRIEF DESCRIPTION OF THE DRAWINGS

For proper understanding of example embodiments, reference should be made to the accompanying drawings, wherein:

FIG. 1 illustrates an example block diagram of an UL NOMA transmitter structure, according to certain embodiments;

FIG. 2 illustrates an example of a NOMA resource utilization scheme, according to some example embodiments;

FIG. 3a illustrates an example flow diagram of a method for NOMA resource utilization scalability, according to one embodiment;

FIG. 3b illustrates an example flow diagram of a method for NOMA resource utilization scalability, according to another embodiment;

FIG. 4a illustrates an example block diagram of an apparatus, according to one embodiment; and

FIG. 4b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for non-orthogonal multiple access (NOMA) resource utilization scalability, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

Non-orthogonal multiple access (NOMA), which was studied in 3^{rd} generation partnership project (3GPP) release 14, allows for different users to use the same time domain and frequency domain resource. As a result, the served user number and system capacity can be improved as compared with the orthogonal multiple access (OMA) scheme. NOMA may be more attractive working with grant free/contention based transmission and, therefore, the downlink (DL) control overhead may be reduced. NOMA can be applied in different scenarios, such as massive machine type communication (mMTC), eMBB, URLLC, and with different usage scenarios. Various usage scenarios may be distinguished, for example, via the typical transport block size (TBS) in a scenario and/or reliability requirements of a scenario. For example, typical transport block sizes for mMTC are rather small. On the other hand, high reliability requirements of transmissions in a scenario may imply a higher number or repetitions, that is, a higher number of transmitted versions relating to the same information. These versions may be spread (or distributed) over a certain resource range on the physical layer, such as a certain number of physical resource blocks (PRB), where each version may occupy a certain basic block of resource elements on the physical layer. Specifically, the occupied block of resource elements may be a set of PRBs.

Generally, the NOMA schemes under consideration can be categorized as spreading based schemes and interleaver/scrambling based schemes. One important aspect to evaluate NOMA scheme performance is the NOMA resource usage flexibility, for example, where the spreading factor for a spreading based scheme or repetition number for an interleaver/scrambling based scheme can be 4, 6, 8, or 12, which is dependent on the different NOMA schemes. In that sense, the minimum physical resource block (PRB) number for NOMA usage can correspondingly be 4, 6, 8, or 12. In addition, the provided data rates for mMTC, URLLC and eMBB are different. Thus, multiple transport block (TB) sizes would be defined and the required physical layer resource for multiple TB sizes would be different. Ways to multiplex mMTC users, URLLC users and eMBB users in the same physical layer resources need to be considered. In other words, since transmissions from UEs for different use cases, such as mMTC, URLLC and eMBB, are multiplexed into the same resources, the different use cases lead to different sizes of the transport blocks.

Therefore, the efficient usage of the physical layer resource is a key issue for NOMA. As resource utilization scalability is an important aspect for NOMA, this will likely be considered as one of the objectives in NOMA design. According to certain 3GPP agreements, the assumption is that 6 PRBs are allocated to UE for mMTC, and 12 PRBs allocated for URLLC and eMBB for MOMA scheme evaluation.

Certain embodiments provide solutions to support NOMA resource utilization scalability. In one embodiment, the network may configure the number of PRBs for NOMA application in a cell-specific manner for all three NOMA usage scenarios, e.g., mMTC, URLLC, eMBB, in other words, the users from different scenarios are multiplexing together. As an example, in an embodiment, a parameter Y may refer to the total number of PRBs allocated to NOMA application and may be configured in cell-specific manner, and another cell-specific parameter X may refer to a resource unit/resource block, e.g., X PRBs. According to one embodiment, the parameter X may be determined by the spreading factor (for a spreading based NOMA scheme) or the repetition number of encoded bit (for an interleaver/scrambling based NOMA scheme). For example, if the network configures the spreading factor equal to X, then the resource unit/block includes X PRBs. In an embodiment, the following formula may be used to determine the total number of PRBs allocated to NOMA: Y=m*X, where the parameter m may represent the block of X PRBs and m may be an integer greater than or equal to 1 (e.g., m=1, 2, 3 . . . ). As discussed above, the parameter X may represent the spreading factor for a spreading based NOMA scheme, or may represent the repetition number of encoded bit for an interleaver/scrambling based NOMA scheme. According to an embodiment, to achieve more flexibility, Y=m*X+k, where 1<=k<=X.

In an embodiment, for a specific user, the configured maximum number of PRB(s) for NOMA can be N, where N<=Y, N=n*X, and n may be an integer greater than or equal to 1 (e.g., n=1, 2, 3 . . . ). In other words, the parameter N is UE-specific parameter, if N is not configured, the UE may assume N=Y. For each transmission, the actually used PRB(s) may be indicated by n, which is determined by corresponding transport block size (TBS). According to some embodiments, serval data mapping patterns may be defined to indicate N PRBs data mapping onto Y PRBs. In one embodiment, the network may indicate which mapping pattern is applied for a user, e.g., pattern Z. In another embodiment, a UE may select a pattern and indicate to the gNB through grant-free UL control.

In an example of a first pattern (Pattern 1), for the case of N=Y, depending on the incoming packet size, the user can select: (1) mapping to X PRBs with TBS #1 and repeat data in the left (m−1) blocks; (2) mapping to 2X PRBs with TBS #2 and repeat data in the left (m−2) blocks; (3) mapping to 3X PRBs with TBS #3 and repeat data in the left (m−3) blocks, and so on. According to certain embodiments, the UE may indicate which kind of mapping it used or the network (e.g., BS or gNB) can perform blind detection. In this example first pattern (Pattern 1), for the case of Y=m*X+k, user data may map onto m*X PRBs first, where m is determined according to transport block size (TBS) then repeat partially on the remaining k PRBs.

In an example of a second pattern (Pattern 2), which may be a sparse pattern, the user data may be mapped to N PRBs of total Y PRBs, with the frequency domain location determined by UE_ID Mod (m). As one example, if UE_ID Mod (m)=0, then a first block (first X PRBs) is the starting point for UE data mapping, and wrap around operation may be applied within configured Y PRBs.

In an example of a third pattern (Pattern 3), which may be a sparse pattern, the user data after spreading may be mapped onto Y PRBs directly. If UE_ID Mod (m)=0, then user data may be mapped on the first resource element (RE) (and continuing n REs) of every m REs in frequency domain in time first manner.

It should be noted that the mapping patterns discussed above are just some examples and other mapping patterns are not precluded according to certain embodiments.

In one embodiment, the network may configure the number of PRBs for NOMA application in a cell-specific manner for a specific NOMA usage scenario. In other words, for example, the network may allocate a dedicated physical layer resource for mMTC, URLLC, eMBB separately, and the method mentioned above may still be applied in this case.

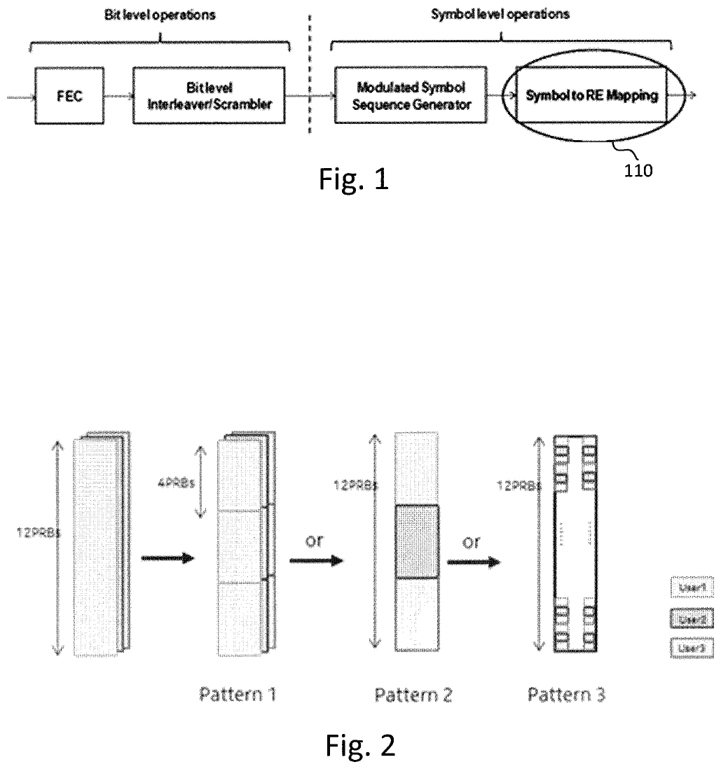

FIG. 1 illustrates an example block diagram of an UL NOMA transmitter structure (see 3GPP TR 38.802). Certain embodiments may relate to the Symbol to RE mapping block 110 of FIG. 1.

FIG. 2 illustrates an example of a NOMA resource utilization scheme, according to example embodiments. More specifically, FIG. 2 illustrates different mapping pattern examples for NOMA scaling, according to some embodiments described herein. In the example of FIG. 2, it may be assumed that the spreading factors are in the range of [4, 8, 12, 16], and the network configured spreading factor is 4, i.e., X=4. Further, in this example, the allocated PRBs for NOMA usage is Y=12 and each user would use 4 PRBs as the basic unit (X=4), and therefore the data would occupy 4 PRBs (N=4) and user data will be mapped onto 12 PRBs according to the defined mapping patterns.

Referring to the example of FIG. 2, with the Pattern 1, data from a user may be mapped onto 4 PRBs, then repeated on the other remaining 8 PRBs. As shown in FIG. 2, each user may occupy the entire configured 12 PRBs, and three users may use the same time and frequency resources. When system load is lower, e.g., small number of users transmit at the same time, the interference among users is lower. Thus, this pattern can be configured to users to obtain the frequency domain repetition gain with less interference.

With the Pattern 2, the user data may be spread to 4 PRBs first, then data may be mapped onto 12 PRBs with the specific patterns. For example, according to user ID (UE_ID), the data from user 1 may be mapped onto the first 4 PRBs, data from user 2 may be mapped onto the second 4 PRBs, and data from user 3 may be mapped onto the third 4 PRBs. If more users (e.g., more than 3) are transmitting at the same time, the data from different users will be overlapped in frequency domain. The overloading rate for this pattern is lower.

With the Pattern 3, the user data may be mapped directly to 12 PRBs with sparse pattern. For example, according to the UE_ID, user 1 may map data on the first RE of every 3REs, and the user 2 may map data on the second RE of every 3REs. For this pattern, the frequency diversity is achievable. If more users (e.g., more than 3) are transmitting at the same time, the data from different users will be overlapped in the same RE. This pattern may be suitable for higher system load scenario.

The NOMA resource utilization scheme, as provided by example embodiments, is adaptive to different TBSs, and is suitable for different NOMA use scenarios, such as mMTC, eMBB, and URLLC. As an example, if a small packet is expected for URLLC, but moderate packet size for eMBB, then the network can configure a user with URLLC service with Y PRBs (the actual used PRBs are X) and configure eMBB users with N PRBs for physical uplink shared channel (PUSCH) transmission to transmit more data. In addition, according certain embodiments of the NOMA resource utilization scalability scheme, mMTC, eMBB and URLLC application can be multiplexed in the same frequency resources.

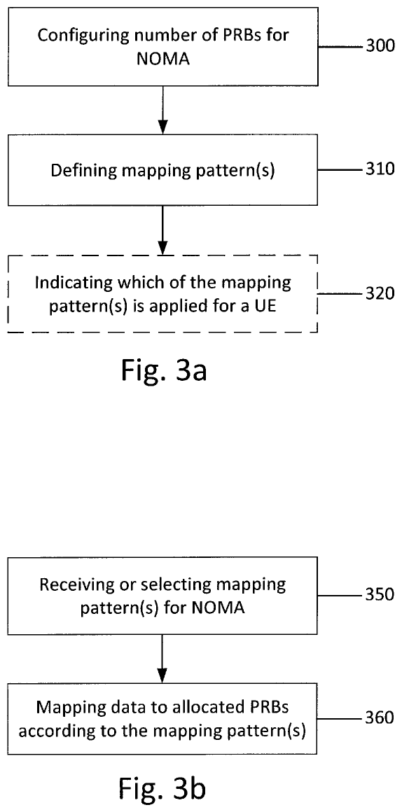

FIG. 3a illustrates an example flow diagram of a method for NOMA resource utilization scalability, according to one embodiment. In certain embodiments, the flow diagram of FIG. 3a may be performed by a network node, such as a base station, node B, eNB, gNB, or any other network or access node. As illustrated in the example of FIG. 3a, the method may include, at 300, configuring or determining the number of PRBs allocated for NOMA usage in a cell-specific manner (e.g., configuring parameters Y and X discussed below). According to an example embodiment, at least one parameter may be configured and used in the determination of the number of PRBs allocated for NOMA usage. In certain example embodiments, the parameter may refer to a spreading factor for a spreading based NOMA scheme (e.g., parameter X discussed below), or may refer to a repetition number for an interleaver/scrambling based NOMA scheme.

For example, in an embodiment, the configuring 300 may include determining the number of PRBs allocated for NOMA according to the following formula: Y=m*X, where Y is a parameter representing the total allocated PRBs for NOMA usage, X is the spreading factor, and m is an integer greater than or equal to 1. In another example embodiment, the formula may be modified to allow more flexibility as follows: Y=m*X+k, where 0<=k<=X. According to certain embodiments, for a specific UE, the number of PRBs configured for NOMA may be given by N in the following formula: N=n*X, where N<=Y, n is an integer greater than or equal to 1, and X again represents the spreading factor. In one example embodiment, the UE may be configured to adaptively select the PRBs according to the TBS via the parameter n.

Referring again to FIG. 3a, in one embodiment, the method may also include, at 310, defining one or more mapping patterns to indicate a mapping of user data to the allocated PRBs for NOMA. According to one embodiment, the mapping patterns may include a first pattern (e.g., corresponding to Pattern 1 discussed above). In this example first pattern, for the case of N=Y, depending on the incoming packet size, the UE may select: (1) mapping user data to X PRBs with TBS #1 and repeat data in the left (m−1) blocks; (2) mapping user data to 2X PRBs with TBS #2 and repeat data in the left (m−2) blocks; (3) mapping user data to 3X PRBs with TBS #3 and repeat data in the left (m−3) blocks, and so on until the allocated PRBs are mapped to. In this example first pattern, for the case of Y=m*X+k, user data may map onto m*X PRBs first, where m is determined according to TBS, then repeated partially on the remaining k PRBs. Thus, in an example of a first pattern, user data may be mapped onto n*X PRBs, then repeat the data in total PRBs allocated for NOMA.

According to an embodiment, the mapping patterns may include a second pattern (e.g., corresponding to Pattern 2 discussed above) in which the user data may be mapped to N PRBs of total Y PRBs, with the frequency domain location determined by UE_ID Mod (in). As one example of this second pattern, if UE_ID Mod (m)=0, then a first block (first X PRBs) is the starting point for UE data mapping, and wrap around operation may be applied within configured Y PRBs. Hence, in an example of a second pattern, the user data is mapped to n*X PRBs of total PRBs allocated for NOMA.

According to an embodiment, the mapping patterns may include a third pattern (e.g., corresponding to Pattern 3 discussed above) in which the user data after spreading may be mapped onto Y PRBs directly. As one example of this third pattern, if UE_ID Mod (m)=0, then user data may be mapped on the first resource element (RE) (and continuing n REs) of every m REs in frequency domain in a time first manner.

In an embodiment, the example method of FIG. 3a may optionally include, at 320, indicating, to a UE, which of the mapping patterns should be applied for the UE. Alternatively, in another embodiment, the UE may select the mapping pattern to apply on its own and, in this case, the network node may receive an indication, from the UE, of which mapping pattern it selected. According to one example, the indication may be uplink control information that includes modulation and coding scheme (MCS) information and/or the PRB numbers used for transmission, e.g., parameter n, or other information.

FIG. 3b illustrates an example flow diagram of a method for NOMA resource utilization scalability, according to another embodiment. In certain embodiments, the method of FIG. 3b may be performed by a UE, mobile station, mobile equipment, IoT device, or the like. As illustrated in the example of FIG. 3b, the method may include, 350, receiving or selecting one or more mapping patterns to use for mapping of user data to allocated PRBs for NOMA. In certain examples, the received or selected mapping pattern(s) may be any one of the example mapping patterns discussed herein, such as Pattern 1, Pattern 2, or Pattern 3 illustrated in FIG. 2. In one example embodiment, when the mapping pattern(s) to use is selected by the UE, the method may include indicating the selected mapping pattern to the network (e.g., to the gNB), for instance, via grant-free UL control. In one example, the UL control information may include MCS information and/or the PRB numbers used for transmission, e.g., parameter n, or other information. According to an embodiment, the method may then include, at 360, mapping the user data to the PRBs allocated for NOMA according to the received or selected mapping pattern(s).

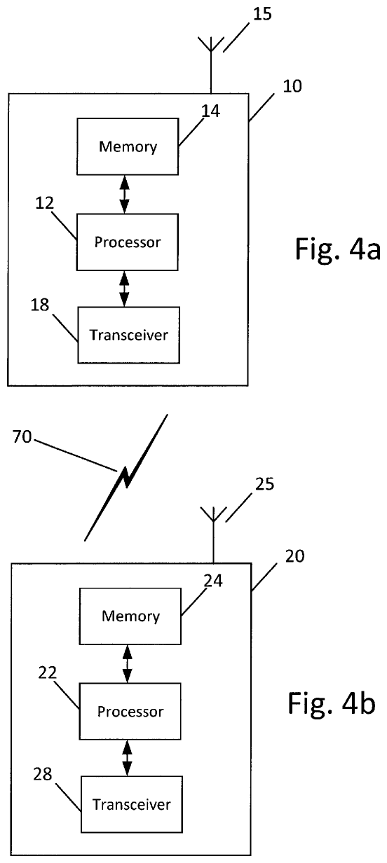

FIG. 4a illustrates an example of an apparatus 10 according to an embodiment. In an embodiment, apparatus 10 may be a node, host, or server in a communications network or serving such a network. For example, apparatus 10 may be a base station, a Node B, an evolved Node B (eNB), 5G Node B or access point, next generation Node B (NG-NB or gNB), WLAN access point, mobility management entity (MME), and/or subscription server associated with a radio access network, such as a GSM network, LTE network, 5G or NR.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 4a.

As illustrated in the example of FIG. 4a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 4a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like. According to certain embodiments, apparatus 10 may be controlled by memory 14 and processor 12 to perform the functions associated with any of the embodiments described herein, such as the flow or signaling diagram illustrated in FIG. 3a or 3b. For example, in certain embodiments, apparatus 10 may be controlled by memory 14 and processor 12 to perform one or more of the steps illustrated in FIG. 3a. In certain embodiments, apparatus 10 may be configured to perform a procedure for NOMA resource utilization scalability.

For instance, in one embodiment, apparatus 10 may be controlled by memory 14 and processor 12 to configure or determine the number of PRBs that should be allocated for NOMA usage in a cell-specific manner According to an example embodiment, at least one parameter may be configured and used in the determination of the number of PRBs allocated for NOMA usage. In certain example embodiments, the parameter may refer to a spreading factor for a spreading based NOMA scheme (e.g., parameter X), or may refer to a repetition number for an interleaver/scrambling based NOMA scheme.

For example, in an embodiment, apparatus 10 may be controlled by memory 14 and processor 12 to determine the number of PRBs allocated for NOMA according to the following formula: Y=m*X, where Y is a parameter representing the total allocated PRBs for NOMA usage, X is the spreading factor, and m is an integer greater than or equal to 1. In another example embodiment, the formula used to determine the number of PRBs allocated for NOMA may be modified to allow more flexibility as follows: Y=m*X+k, where 0<=k<=X. According to certain embodiments, for a specific UE, the number of PRBs configured for NOMA may be given by N in the following formula: N=n*X, where N<=Y, n is an integer greater than or equal to 1, and X again represents the spreading factor. In one example embodiment, the UE may be configured to adaptively select the PRBs according to the TBS via the parameter n.

In one embodiment, apparatus 10 may be controlled by memory 14 and processor 12 to define one or more mapping patterns to use for the mapping of user data to the allocated PRBs for NOMA. According to one embodiment, the mapping patterns may include a first pattern (e.g., corresponding to Pattern 1 discussed above). In this example first pattern, for the case of N=Y, depending on the incoming packet size, the user can select: (1) mapping to X PRBs with TBS #1 and repeat data in the left (m−1) blocks; (2) mapping to 2X PRBs with TBS #2 and repeat data in the left (m−2) blocks; (3) mapping to 3X PRBs with TBS #3 and repeat data in the left (m−3) blocks, and so on. In this example first pattern, for the case of Y=m*X+k, user data may map onto m*X PRBs first, where m is determined according to TBS, then repeated partially on the remaining k PRBs. Thus, in an example of a first pattern, user data may be mapped onto n*X PRBs, then repeat the data in total PRBs allocated for NOMA.

According to an embodiment, the mapping patterns may include a second pattern (e.g., corresponding to Pattern 2 discussed above) in which the user data may be mapped to N PRBs of total Y PRBs, with the frequency domain location determined by UE_ID Mod (in). As one example of this second pattern, if UE_ID Mod (m)=0, then a first block (first X PRBs) is the starting point for UE data mapping, and wrap around operation may be applied within configured Y PRBs. Hence, in an example of a second pattern, the user data is mapped to n*X PRBs of total PRBs allocated for NOMA.

According to an embodiment, the mapping patterns may include a third pattern (e.g., corresponding to Pattern 3 discussed above) in which the user data after spreading may be mapped onto Y PRBs directly. As one example of this third pattern, if UE_ID Mod (m)=0, then user data may be mapped on the first resource element (RE) (and continuing n REs) of every m REs in frequency domain in a time first manner.

In an embodiment, apparatus 10 may optionally be controlled by memory 14 and processor 12 to indicate, to a UE, which of the mapping patterns should be applied for the UE. Alternatively, in another embodiment, the UE may select the mapping pattern to apply on its own and, in this case, apparatus 10 may optionally be controlled by memory 14 and processor 12 to receive an indication, from the UE, of which mapping pattern it selected. According to one example, the indication may be uplink control information that includes modulation and coding scheme (MCS) information and/or the PRB numbers used for transmission, e.g., parameter n.

FIG. 4b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4b.

As illustrated in the example of FIG. 4b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 10 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as the flow diagrams illustrated in FIG. 3a or 3b. For example, in certain embodiments, apparatus 20 may be configured to perform a procedure for NOMA resource utilization scalability.

According to some embodiments, apparatus 20 may be controlled by memory 24 and processor 22 to receive or select one or more mapping patterns to use for mapping of user data to allocated PRBs for NOMA. In certain examples, the received or selected mapping pattern(s) may be any one of the example mapping patterns discussed herein, such as Pattern 1, Pattern 2, or Pattern 3 illustrated in FIG. 2. In one example embodiment, when apparatus 20 selects the mapping pattern(s) to use, apparatus 20 may be controlled by memory 24 and processor 22 to indicate the selected mapping pattern to the network (e.g., to the gNB), for instance, via grant-free UL control. According to one example, the uplink control information may include MCS information and/or the PRB numbers used for transmission, e.g., parameter n. According to an embodiment, apparatus 20 may then be controlled by memory 24 and processor 22 to map the user data to the PRBs allocated for NOMA according to the received or selected mapping pattern(s). In one example embodiment, apparatus 20 may be controlled by memory 24 and processor 22 to adaptively select the PRBs according to the TBS via the parameter n.

Therefore, certain example embodiments provide several technical improvements, enhancements, and/or advantages. Various example embodiments can, for example, achieve scalability with limited standard effort. Certain embodiments are matched to all envisioned NOMA schemes and can apply to both waveforms (e.g., CP-OFDM and SC-FDMA). In addition, example embodiments provide the configuration flexibility to different deployment scenarios, e.g., mMTC, eMBB, and URLLC, by configuring different PRB numbers. Consequently, certain example embodiments may improve the reliability and speed of networks. As such, example embodiments can improve performance, latency, and/or throughput of networks and network nodes including, for example, access points, base stations/eNBs/gNBs, and mobile devices or UEs. Accordingly, the use of certain example embodiments results in improved functioning of communications networks and their nodes.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments. In order to determine the metes and bounds of the example embodiments, therefore, reference should be made to the appended claims.

1-26. (canceled)

27. A method, comprising:
configuring a number of physical resource blocks allocated for non-orthogonal multiple access (NOMA) usage in a cell-specific manner for at least one usage scenario,
wherein at least a parameter is configured and used in determining the number of physical resource blocks allocated for the non-orthogonal multiple access (NOMA),
wherein the parameter refers to at least one of a spreading factor for spreading based NOMA scheme or a repetition number for an interleaver/scrambling based NOMA scheme; and
defining at least one mapping pattern to indicate a mapping of user data to the physical resource blocks.

28. The method according to claim 27, further comprising:
indicating, to a user equipment, which of the at least one mapping pattern to apply for the user equipment.

29. The method according to claim 27, further comprising:
receiving an indication from a user equipment of which mapping pattern was selected by the user equipment.

30. The method according to claim 27, wherein the configuring further comprises determining the number of physical resource blocks allocated for non-orthogonal multiple access (NOMA) according to the following formula:
Y=m*X+k,
wherein Y is a parameter representing the total allocated physical resource blocks for non-orthogonal multiple access (NOMA) usage, X is the spreading factor, m is an integer greater than or equal to 1, and 0<=k<=X.

31. An apparatus, comprising:
at least one processor; and
at least one memory comprising computer program code,
the at least one memory and computer program code configured, with the at least one processor, to cause the apparatus at least to
configure a number of physical resource blocks allocated for non-orthogonal multiple access (NOMA) usage in a cell-specific manner for at least one usage scenario,
wherein at least a parameter is configured and is used in determining the number of physical resource blocks allocated for the non-orthogonal multiple access (NOMA),
wherein the parameter refers to at least one of a spreading factor for spreading based NOMA scheme or a repetition number for an interleaver/scrambling based NOMA scheme; and
define at least one mapping pattern to indicate a mapping of user data to the physical resource blocks.

32. The apparatus according to claim 31, wherein the at least one memory and computer program code are further configured, with the at least one processor, to cause the apparatus at least to:
indicate, to a user equipment, which of the at least one mapping pattern to apply for the user equipment.

33. The apparatus according to claim 31, wherein the at least one memory and computer program code are further configured, with the at least one processor, to cause the apparatus at least to:
receive an indication from a user equipment of which mapping pattern was selected by the user equipment.

34. The apparatus according to claim 31, wherein the at least one memory and computer program code are further configured, with the at least one processor, to cause the apparatus at least to determine the number of physical resource blocks allocated for non-orthogonal multiple access (NOMA) according to the following formula:
Y=m*X+k,
wherein Y is a parameter representing the total allocated physical resource blocks for non-orthogonal multiple access (NOMA) usage, X is the spreading factor, m is an integer greater than or equal to 1, and 0<=k<=X.

35. The apparatus according to claim 34, wherein, for a specific user equipment, the number of physical resource blocks configured for non-orthogonal multiple access (NOMA) is given by N in the following formula:
N=n*X,
wherein N<=Y, n is an integer greater than or equal to 1, and X represents the spreading factor.

36. The apparatus according to claim 31, wherein, the user equipment adaptively selects the physical resource blocks according to the transport block size via parameter n.

37. The apparatus according to claim 31, wherein the at least one mapping pattern comprises at least one of:
a first pattern in which, user data is mapped onto n*X physical resource blocks, then repeat the data in total physical resource blocks allocated for non-orthogonal multiple access;
a second pattern in which the user data is mapped to n*X physical resource blocks of total physical resource blocks allocated for non-orthogonal multiple access; or
a third pattern in which the user data after spreading is mapped onto Y physical resource blocks directly.

38. The apparatus according to claim 33, wherein the indication comprises uplink control information that includes at least one of modulation and coding scheme (MCS) information or physical resource block (PRB) numbers used for transmission.

39. A non-transitory computer readable medium comprising program instructions stored thereon for performing at least the following:
configuring a number of physical resource blocks allocated for non-orthogonal multiple access (NOMA) usage in a cell-specific manner for at least one usage scenario,
wherein at least a parameter is configured and is used in determining the number of physical resource blocks allocated for the non-orthogonal multiple access (NOMA),
wherein the parameter refers to at least one of a spreading factor for spreading based NOMA scheme or a repetition number for an interleaver/scrambling based NOMA scheme; and
defining at least one mapping pattern to indicate a mapping of user data to the physical resource blocks.

40. A method, comprising:
receiving or selecting, by a user equipment, at least one mapping pattern for at least one usage scenario to use for mapping of user data to allocated physical resource blocks for non-orthogonal multiple access (NOMA); and
mapping the user data to the physical resource blocks allocated for the non-orthogonal multiple access (NOMA) according to the at least one mapping pattern.

41. The method according to claim 40, wherein, when the user equipment selects the at least one mapping pattern, the method further comprises indicating the selected at least one mapping pattern to a network node.

42. The method according to claim 40, wherein the at least one mapping pattern comprises at least one of:
a first pattern in which, user data is mapped onto n*X physical resource blocks, then repeat the data in total physical resource blocks allocated for non-orthogonal multiple access;
a second pattern in which the user data is mapped to n*X physical resource blocks of total physical resource blocks allocated for non-orthogonal multiple access; or
a third pattern in which the user data after spreading is mapped onto Y physical resource blocks directly.

43. An apparatus, comprising:
at least one processor; and
at least one memory comprising computer program code,
the at least one memory and computer program code configured, with the at least one processor, to cause the apparatus at least to
receive or select at least one mapping pattern for at least one usage scenario to use for mapping of user data to allocated physical resource blocks for non-orthogonal multiple access (NOMA); and
map the user data to the physical resource blocks allocated for the non-orthogonal multiple access (NOMA) according to the at least one mapping pattern.

44. The apparatus according to claim 43, wherein, when the apparatus selects the at least one mapping pattern, the at least one memory and computer program code are further configured, with the at least one processor, to cause the apparatus at least to indicate the selected at least one mapping pattern to a network node.

45. The apparatus according to claim 43, wherein the at least one mapping pattern comprises at least one of:
a first pattern in which, user data is mapped onto n*X physical resource blocks, then repeat the data in total physical resource blocks allocated for non-orthogonal multiple access;
a second pattern in which the user data is mapped to n*X physical resource blocks of total physical resource blocks allocated for non-orthogonal multiple access; or
a third pattern in which the user data after spreading is mapped onto Y physical resource blocks directly.

46. A non-transitory computer readable medium comprising program instructions stored thereon for performing at least the following:
receiving or selecting at least one mapping pattern for at least one usage scenario to use for mapping of user data to allocated physical resource blocks for non-orthogonal multiple access (NOMA); and
mapping the user data to the physical resource blocks allocated for the non-orthogonal multiple access (NOMA) according to the at least one map
